(19) United States
(12) Patent Application Publication
(10) Pub. No.: US 2009/0091715 A1
(43) Pub. Date: Apr. 9, 2009

(54) EXPOSURE APPARATUS, EXPOSURE METHOD, AND DEVICE MANUFACTURING METHOD

(75) Inventor: Takatoshi Tanaka, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/203,317

(22) Filed: Sep. 3, 2008

(30) Foreign Application Priority Data
Oct. 4, 2007 (JP) 2007-261019

(51) Int. Cl. G03B 27/52

(52) U.S. Cl. 355/30; 355/77

(57) ABSTRACT

An exposure apparatus configured to expose a substrate through a liquid includes a projection optical system configured to project an image of a pattern formed on an original plate onto a substrate and a stage configured to move while supporting the substrate. Further, the exposure apparatus includes a member including a supply port and a recovery port of the liquid that is arranged between the stage and the projection optical system such that a space is formed between the projection optical system and the member, and a supply unit configured to supply inactive gas through an outlet port into a space between the projection optical system and the member. The outlet port is directed to the space.

### BACKGROUND OF THE INVENTION

1. Field of the Invention

The present invention relates to an exposure apparatus, an exposure method, and a device manufacturing method.

2. Description of the Related Art

Conventionally, an exposure apparatus is used for transferring a circuit pattern formed on a reticle (mask) onto a wafer by a projection optical system. In recent years, in order to meet a growing demand for higher resolution, an exposure method called immersion exposure is attracting attention. By using a liquid (an immersion liquid) as a medium on a wafer side of a projection optical system, an exposure apparatus using the immersion exposure method is capable of increasing numerical aperture (NA) of the projection optical system. More specifically, where refractive index of a medium is “n”, since NA of the projection optical system is n·sin θ, NA can be increased to “n” by using a medium having a higher refractive index (n>1) than air. In this way, increase of NA can be achieved.

Currently, some kinds of liquid having high refractive index which can be used for the immersion exposure apparatus have high oxygen solubility. When oxygen dissolves in such a liquid, transmissivity of exposure light of the liquid decreases, which results in reduced resolution. Thus, in order to prevent oxygen from dissolving in the liquid, a periphery of the liquid is filled with inactive gas such as nitrogen, argon, or helium so as to maintain low oxygen concentration of the liquid (see Japanese Patent Application Laid-Open No. 2006-173295 and Japanese Patent Application Laid-Open No. 2005-183744).

As described in Japanese Patent Application Laid-Open No. 2006-173295 and Japanese Patent Application Laid-Open No. 2005-183744, it is useful to separate a member including a supply port or a recovery port used for supplying or recovering the immersion liquid from the projection optical system. Thus, vibration which occurs when the liquid is supplied or recovered, is prevented from transmitting to the projection optical system.

However, if the member including the supply port or the recovery port is separated from the projection optical system, a gap is made between the member having the supply port or the recovery port and the members that constitute the projection optical system. The inactive gas cannot be easily supplied to such a gap. Accordingly, oxygen in the gap dissolves in the liquid and thus oxygen concentration of the liquid is not reduced to a satisfactory level. Further, since a gap between a final lens of the projection optical system and a wafer or a coplanar plate is extremely narrow, it is difficult to reduce oxygen concentration in the gap.

### SUMMARY OF THE INVENTION

The present invention is directed to an exposure apparatus and an exposure method capable of reducing oxygen concentration in a liquid used for immersion exposure.

According to an aspect of the present invention, an exposure apparatus configured to expose a substrate through a liquid includes a projection optical system configured to project an image of a pattern formed on an original plate onto a substrate and a stage configured to move while supporting the substrate. Further, the exposure apparatus includes a member including a supply port and a recovery port of the liquid that is arranged between the stage and the projection optical system such that a space is formed between the projection optical system and the member, and a supply unit configured to supply inactive gas through an outlet port into a space between the projection optical system and the member. The outlet port is directed to the space.

According to another aspect of the present invention, an exposure apparatus configured to expose a substrate through a liquid includes a projection optical system configured to project an image of a pattern formed on an original plate onto a substrate, a stage configured to move while supporting the substrate, a member including a supply port and a recovery port of the liquid that is arranged between the stage and the projection optical system such that a space is formed between the projection optical system and the member, a supply unit configured to supply inactive gas through an outlet port into a space between the stage and the member, and a recovery unit configured to recover the inactive gas supplied by the supply unit through a recovery port. The outlet port of the supply unit and the recovery port of the supply unit are provided on a face of the stage opposing the projection optical system.

According to yet another aspect of the present invention, an exposure method for exposing a substrate through a projection optical system and a liquid by projecting an image of a pattern formed on an original plate onto the substrate includes supplying inactive gas in a space between a member including a supply port and a recovery port of the liquid, and the projection optical system through an outlet port directed to the space, supplying the liquid to a space between the projection optical system and the substrate after supplying the inactive gas, and exposing the substrate through the liquid supplied to a space between the projection optical system and the substrate.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example configuration of an exposure apparatus according to a first exemplary embodiment of the present invention.

FIG. 2 illustrates a cross section of a space between a final optical element of a projection optical system and a top surface of a wafer, which is hereinafter referred to as an “optical path space”.

FIG. 3 illustrates a cross section of the optical path space according to a second exemplary embodiment of the present invention.

FIG. 4 illustrates a cross section of an optical path space according to a third exemplary embodiment of the present invention.

FIG. 5 illustrates a cross section of an optical path space with an inactive gas outlet according to a fourth exemplary embodiment of the present invention.

FIG. 6 illustrates a cross section of an optical path space with an inactive gas outlet according to a fifth exemplary embodiment of the present invention.

FIG. 7 is a flowchart illustrating an exposure method according to an exemplary embodiment of the present invention.

FIGS. 8A through 8D illustrate the exposure method according to an exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

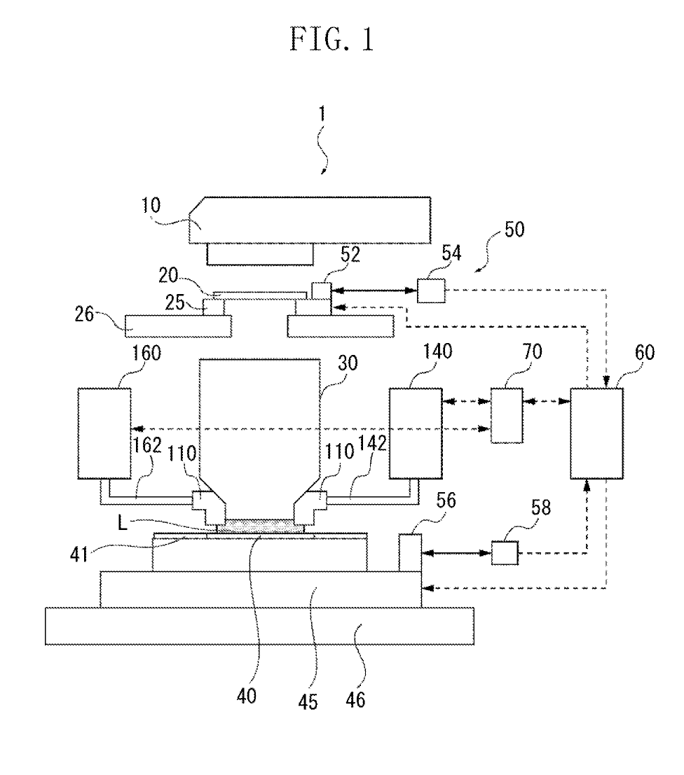

FIG. 1 illustrates an example configuration of an exposure apparatus according to a first exemplary embodiment of the present invention. Arrows illustrated in FIG. 1 indicate flow of data.

The exposure apparatus 1 is an immersion type projection exposure apparatus by which a circuit pattern formed on a reticle is projected onto the wafer through a liquid L (an immersion liquid) which is supplied in a space between a wafer and a final face of an optical element (a final optical element) on the wafer side of the projection optical system 30.

The projection exposure apparatus are classified into two types: one type employs a step-and-repeat system and the other employs a step-and-scan system. The present exemplary embodiment is described based on an exposure apparatus employing the step-and-scan system. This type of exposure apparatus is called a “scanner”. According to the step-and-scan system, the wafer is continuously scanned with the reticle while a pattern formed on a reticle is transferred onto the wafer. The wafer is step-transferred to the next exposure area after one shot is finished. On the other hand, according to the step-and-repeat system, a wafer is exposed collectively by a single shot. Then, the wafer is step-transferred to the next exposure area.

As illustrated in FIG. 1, the exposure apparatus 1 includes an illumination apparatus 10, a reticle stage 25 configured to hold a reticle 20, the projection optical system 30, a wafer stage 45 configured to hold a wafer 40, a distance measurement unit 50, a stage controller 60, and a fluid controller 70.

The illumination apparatus 10 includes a light source unit (not shown) and an illumination optical system (not shown) used for illuminating the reticle 20 on which a circuit pattern is formed.

As a light source of the light source unit, for example, argon fluoride (ArF) excimer laser with a wavelength of 193 nm or krypton fluoride (KrF) excimer laser with a wavelength of 248 nm can be used. However, the light source is not limited to excimer laser and, for example, molecular fluorine (F2) laser with a wavelength of 157 nm can also be used. The number of light sources is not limited. Further, the light source used for the light source unit is not limited to laser and one or a plurality of mercury lamps or xenon lamps can also be used.

The illumination optical system is configured to illuminate the reticle 20. The illumination optical system includes components such as a lens, a mirror, an optical integrator, and a diaphragm. For example, the components are arranged in an order of a condenser lens, a fly-eye lens, an aperture diaphragm, a condenser lens, a slit, and an image forming optical system. According to the present exemplary embodiment, the optical integrator is an integrator having a fly-eye lens and two sets of cylindrical lens array (or lenticular lens) plate which are stacked. However, the optical integrator can be replaced with an optical rod or a diffraction element.

The reticle (mask) 20 as an original plate is conveyed to the reticle stage 25 from outside of the exposure apparatus 1 by a reticle conveying system (not shown) and is supported and driven by the reticle stage 25. The reticle 20 is, for example, made of quartz. A circuit pattern which is to be transferred is formed on the reticle 20. Diffracted light from the reticle 20 passes through the projection optical system 30 and is projected onto the wafer 40. The reticle 20 is located in a position optically conjugate with the wafer 40. The exposure apparatus 1 transfers the pattern formed on the reticle 20 onto the wafer 40 by scanning the reticle 20 and the wafer 40 at a velocity ratio corresponding to the demagnification ratio. The exposure apparatus employing the step-and-repeat system, which is also called a “stepper”, projects the pattern formed on the reticle 20 while the reticle 20 and the wafer 40 are in a stationary state.

The reticle stage 25 is fixed to a support member 26. The reticle stage 25 supports the reticle 20 through a reticle chuck (not shown). Movement of the reticle stage 25 is controlled by a move mechanism and a stage controller 60 (not shown). The move mechanism includes, for example, a linear motor. The move mechanism moves the reticle 20 by driving the reticle stage 25 in the X-axis direction.

The projection optical system 30 has a function of forming an image on the wafer 40 with diffracted light that has passed through the pattern formed on the reticle 20. As the projection optical system 30, an optical system that consists of only a plurality of lens elements or an optical system including a plurality of lens elements, and at least one concave mirror (catadioptric optical system) can be used.

Alternatively, an optical system having a plurality of lens elements and at least one diffractive optical element such as a kinoform element can be used as the projection optical system 30. If correction of chromatic aberration is necessary, a plurality of lens elements made from glass materials having different dispersion (Abbe's number) will be used or the diffractive optical element is configured so that dispersion in a direction opposite to the dispersion of the lens elements occurs.

The wafer 40 as a substrate is conveyed onto the wafer stage 45 from outside the exposure apparatus 1 by a wafer conveying system (not shown) and is supported and driven by the wafer stage 45. The wafer 40 is coated with photoresist. A substrate such as a liquid crystal substrate or the like can be used in place of the wafer 40. In order to start exposure from an end of the wafer 40, liquid film needs to be formed in a space below the final face (undersurface) of the projection optical system 30 before the end of the wafer 40 reaches the exposure area (area irradiated with exposure light). Thus, a coplanar plate 41 having a height substantially the same as the wafer 40 is arranged outside of the wafer 40 so that a liquid film is also formed in the outer side of the wafer.

The wafer stage 45 supports the wafer 40 and is mounted on a support member 46. The wafer stage 45 includes an internal driving device configured to adjust, change, and control a position of the wafer 40 in the vertical and rotational directions and an inclination of the wafer 40. During exposure, the wafer stage 45 is controlled by the driving device so that the exposure area on the wafer 40 coincides with a focal plane of the projection optical system 30 with high precision. The position of the face of the wafer (position in the vertical direction and inclination) is measured by an optical focus sensor (not shown) and the measurement result is sent to the stage controller 60. The wafer stage 45 moves a predetermined area of the wafer 40 directly below the projection optical system 30 or makes postural correction of the wafer 40.

The distance measurement unit 50 measures a position of the reticle stage 25 and a two-dimensional position of the wafer stage 45 through reference mirrors 52 and 56 and laser interferometers 54 and 58 in real time. The distance measured by the distance measurement unit 50 is sent to the stage controller 60. The reticle stage 25 and the wafer stage 45 are driven at a constant velocity ratio for positioning or for synchronization control under control of the stage controller 60.

The stage controller 60 controls drive of the reticle stage 25 and the wafer stage 45.

The fluid controller 70 acquires information such as a current position, speed, acceleration, target position, and direction of movement of the wafer stage 45 from the stage controller 60. Based on such information, the fluid controller 70 performs control regarding the immersion exposure. For example, the fluid controller 70 issues control commands such as switching between supply and recovery of the liquid L, stopping of supply or recovery, and controlling of the liquid L to be supplied or recovered to a liquid supply apparatus 140 or a liquid recovery unit 160. Further, the fluid controller 70 issues control commands such as switching between supply and recovery of the inactive gas, stopping of supply or recovery, and controlling of the inactive gas to be supplied or recovered to the supply unit or the recovery unit.

A main body of the exposure apparatus 1 is installed within an environment chamber (not shown). Thus, temperature of the environment surrounding the exposure apparatus 1 is controlled at a predetermined level. Air-conditioned and temperature-controlled air is blown to spaces surrounding the reticle stage 25, the wafer stage 45, the interferometers 54 and 58, and the projection optical system 30 so as to maintain the ambient temperature with high precision.

The liquid supply apparatus 140 fills a space or a gap between the projection optical system 30 and the wafer 40 with the liquid L together with a member 110 on which nozzles of supply port and recovery port of liquid and gas are arranged. The liquid supplied by the liquid supply apparatus 140 is recovered by the liquid recovery unit 160.

The liquid L is selected from liquids that have low absorption ratio of exposure light. Further, the liquid L is required to have a refractive index similar to that of dioptric optical elements such as quartz and fluorite. More specifically, the liquid L is selected from, for example, pure water, functional water, and fluorinated liquid (e.g., fluorocarbon).

It is useful to sufficiently remove dissolved gas from the liquid L in advance using a deaerating device. Removing the gas contributes to preventing generation of bubbles. Further, even when bubbles are generated, the bubbles can be immediately absorbed in the liquid. For example, generation of the bubbles can be sufficiently prevented by removing 80% or more of dissolvable amount of nitrogen and oxygen, which are major constituents of air, from the liquid. Furthermore, the liquid can be supplied to the liquid supply apparatus 140 while the dissolved gas in the liquid is removed continuously by a deaerating device (not shown) provided in the exposure apparatus 1. As the deaerating device, for example, a vacuum deaerating device is useful. In the vacuum deaerating device, liquid is lead into one side of a chamber while the other side is in a vacuum. Through a gas-permeable membrane in between, dissolved gas in the liquid is expelled into the vacuum side through the membrane.

The member 110 is an annular member which is arranged to surround the periphery of the projection optical system 30. The member 110 can be set around the projection optical system 30 (at least around a periphery of the final optical element) separated from the projection optical system 30. The member 110 can also be arranged near the projection optical system 30. For example, the distance between the member 110 and the projection optical system 30 can be a few millimeters.

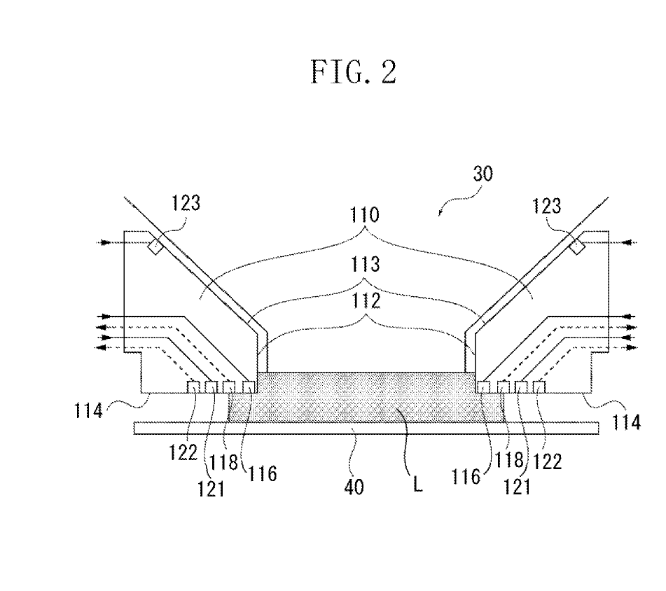

The member 110 (see also FIG. 2) includes a face 112 which is substantially parallel with the optical axis of the projection optical system 30 and a face 114 which is substantially vertical with respect to the face 112. The member 110 contacts the liquid L through the faces 112 and 114, supplies the liquid through a supply port 116, and recovers the liquid through a recovery port 118. The supply port 116 and the recovery port 118 are provided on the face 114.

The liquid supply apparatus 140 supplies the liquid to a space between the projection optical system 30 and the wafer 40 through a supply pipe 142 and the member 110. The liquid supply apparatus 140 includes a storage tank used for storing the liquid, a pressure device used for supplying the liquid, a flow volume adjustment unit configured to adjust a supply volume of the liquid, and a temperature control device configured to control a temperature of the liquid. The liquid supply apparatus 140 operates based on a control command issued by the fluid controller 70.

The liquid recovery unit 160 recovers the liquid from a space between the projection optical system 30 and the wafer 40 through a recovery pipe 162 and the member 110. The liquid recovery unit 160 includes a tank used for temporarily storing the recovered liquid, a suction device used for suctioning the liquid, and a flow volume adjustment unit configured to adjust a recovery flow volume of the liquid. The liquid recovery unit 160 also operates based on a control command issued by the fluid controller 70.

Next, the details of the member 110 will be described referring to FIG. 2 which illustrates a cross section of a space between the final optical element of the projection optical system 30 and the top surface of the wafer 40, hereinafter referred to as an “optical path space”. The cross section of the space includes the optical axis of the projection optical system 30. Arrows in FIG. 2 indicate flow of liquid or gas.

The member 110 which is arranged to surround the optical path space has the supply port 116 and the recovery port 118 provided on the face 114 and in positions facing the wafer 40. The supply port 116 is used for supplying the liquid L to the space surrounded by the member 110 and the recovery port 118 is used for recovering the liquid L from the space. The recovery port 118 is arranged to surround the optical path space and defines an outer edge of the space so that the liquid L supplied to the optical path space and below the member 110 does not leak to the vicinity of the member 110 or outside the member 110.

The member 110 according to the present exemplary embodiment includes an inactive gas outlet port (the first outlet port) 123 and an inactive gas outlet port (the second outlet port) 121 used for blowing (supplying) inactive gas, and an inactive gas recovery port 122. According to the present exemplary embodiment, nitrogen, argon, or helium can be used as the inactive gas.

The inactive gas outlet port 123 is provided in a space between the member 110 and the projection optical system 30 on a face 113 of the member 110 opposing the projection optical system 30. An inactive gas supply device as a supply unit is arranged within the exposure apparatus 1 or in an external apparatus. Based on a command issued by the fluid controller 70, inactive gas is supplied from the inactive gas supply device to a space between the member 110 and the projection optical system 30 through a supply pipe (piping) and the inactive gas outlet port 123. The inactive gas supply device includes, for example, a tank that contains the inactive gas, a pressure unit used for supplying the inactive gas, a flow volume adjustment unit configured to adjust the amount of supply of the inactive gas, and a temperature control unit configured to control the temperature of the inactive gas. If the inactive gas is discharged from the inactive gas outlet port 123 when the liquid L is not present in the space between the projection optical system 30 and the wafer 40, the inactive gas can spread in the space between the projection optical system 30 and the wafer 40 or in the space between the member 110 and the wafer 40.

A normal line of the inactive gas outlet port 123 is directed to the space between the member 110 and the projection optical system 30. Accordingly, inactive gas is promptly supplied to the space between the member 110 and the projection optical system 30. The projection optical system 30 includes an optical element and a holding member configured to support the optical element. Further, when mention in the context of the present specification is made of an aperture arranged in a space between the member 110 and the projection optical system 30, the aperture includes an opening that is arranged on a face of the member 110 opposing the space between the member 110 and the projection optical system 30.

Further, according to the present exemplary embodiment, an inactive gas recovery port used for recovering inactive gas can be arranged between the member 110 and the projection optical system 30. The inactive gas recovery port can be arranged on the face 113 of the member 110, opposing the projection optical system 30, or on a member different from the member 110. An inactive gas recovery unit (not shown) is arranged in the exposure apparatus 1 or in an external apparatus. Inactive gas in the space between the member 110 and the projection optical system 30 is recovered by the inactive gas recovery unit through a piping from the inactive gas recovery port. The inactive gas outlet port 123 can also function as an inactive gas recovery port. In this case, only one aperture is necessary on the face 113, thereby a configuration can be simplified.

The inactive gas outlet port 121 is arranged on the face 114 of the member 110 and outside the liquid L. Inactive gas is supplied from the inactive gas outlet port 121 so as to surround the liquid L. A supply device of the inactive gas may be the same as the inactive gas supply device that supplies inactive gas from the inactive gas outlet port 123 but may also be a different device.

The inactive gas recovery port 122 is arranged on the face 114 of the member 110 and outside the liquid L, and recovers the inactive gas supplied to the space between the member 110 and the wafer 40 from the inactive gas outlet port 121. A recovery device of the inactive gas may be the same as the inactive gas recovery device used for recovering the inactive gas in the space between the member 110 and the projection optical system 30 but may also be a different device.

The inactive gas is blown to the periphery of the liquid L through the inactive gas outlet port 121 and the inactive gas recovery port 122. Thus, the inactive gas also serves as an air curtain that confines the liquid L in the space between the projection optical system and the wafer. The inactive gas outlet port 121 and the inactive gas recovery port 122 are not necessarily provided on the member 110 and can be arranged on a different member.

The inactive gas outlet port 123 can be arranged at a position near the optical axis of the projection optical system than the inactive gas outlet port 121. By arranging the inactive gas outlet port 123 in such a position, oxygen concentration in the space between the wafer stage 45 and the projection optical system 30 and in the space between the member 110 and the projection optical system 30 can be reduced sufficiently and quickly.

### Exemplary Exposure Method

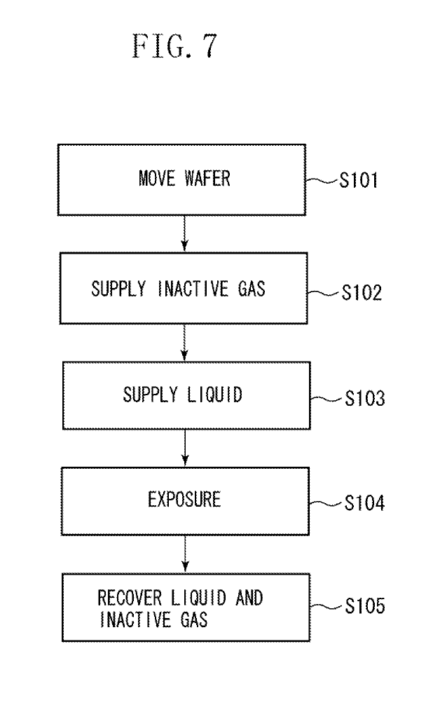

Next, an exposure method using the exposure apparatus according to the present exemplary embodiment will be described referring to FIG. 7. In step S101, the stage controller 60 mounts the wafer 40 on the wafer stage 45 and then moves the wafer 40 to a space below the projection optical system 30.

In step S102, the fluid controller 70 supplies inactive gas from at least the inactive gas outlet port 121 or the inactive gas outlet port 123 which are arranged on the member 110. In this way, air in the space between the projection optical system 30 and the wafer 40 (the wafer stage 45) and air in the space between the projection optical system 30 and the member 110 is replaced with inactive gas. Accordingly, the oxygen concentration in the space can be reduced. At this time, the fluid controller 70 controls supply timing and a flow volume of the inactive gas.

In this case, it is useful to supply the inactive gas while the wafer stage 45 is moving. By supplying the inactive gas while the wafer stage 45 is moving, the inactive gas supplied from an upstream side in a wafer stage scanning direction moves into the optical path space according to the movement of the wafer stage 45.

Next, in step S103, the fluid controller 70 supplies the liquid to a space between the projection optical system 30 and the wafer 40 (the wafer stage 45). Also in this case, it is useful to supply the liquid while the wafer stage 45 is moving. By supplying the liquid while the wafer stage 45 is moving, the liquid supplied from the upstream side in the wafer stage scanning direction can move faster into the optical path space along with the movement of the wafer stage 45.

After the liquid is supplied to the space between the projection optical system 30 and the wafer 40 (the wafer stage 45) (i.e., the optical path space) and the optical path space is filled with the liquid, in step S104, the exposure apparatus 1 projects the pattern formed on the reticle 20 onto the wafer 40.

When projection of all shots is finished, in step S105, the fluid controller 70 recovers the liquid by the liquid recovery unit 160 through a liquid recovery port 118. Further, the fluid controller 70 recovers the inactive gas by the inactive gas recovery unit through the inactive gas recovery port 122. This operation can be repeated if the wafer is changed to another wafer and the exposure process is to be continued.

According to the present exemplary embodiment, since the inactive gas can be supplied to the space where the liquid is filled, especially to the space between the projection optical system and the member having the supply port and the recovery port through which the liquid is supplied or recovered, oxygen concentration of the liquid can be reduced sufficiently and quickly. Further, since leakage of inactive gas to the measurement area of the laser interferometer can be reduced, measurement error (interferometer error due to fluctuation) can be reduced.

### Second Exemplary Embodiment

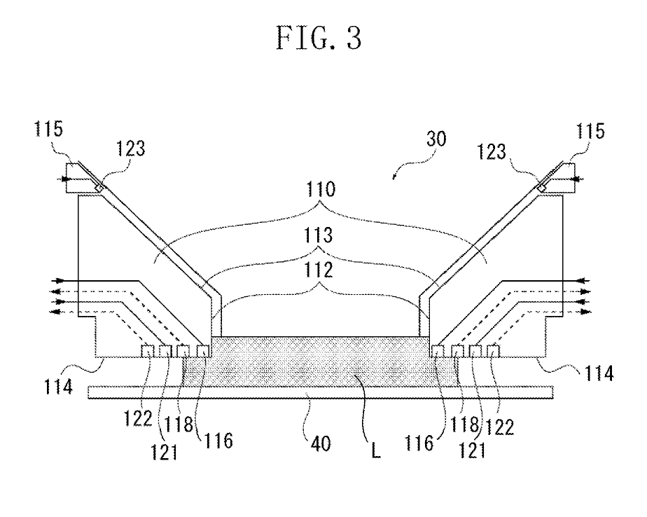

FIG. 3 illustrates a cross section of the optical path space according to a second exemplary embodiment of the present invention. The optical path space includes the optical axis of the projection optical system 30. According to the present exemplary embodiment, the inactive gas supply port 123 is provided on a member different from the member 110. According to the present exemplary embodiment, components similar to those in the first exemplary embodiment are denoted by the same reference numerals and their description is omitted for simplification.

According to the present exemplary embodiment, the inactive gas outlet port 123 is provided on a member 115 which is different from the member 110. A normal line of the inactive gas outlet port 123 is directed to a space between the projection optical system 30 and the member 110. The inactive gas is supplied by a supply device of the inactive gas to the space between the member 110 and the projection optical system 30 through the inactive gas outlet port 123.

The member 115 can have its outlet port directed to the space between the projection optical system 30 and the member 110. Further, the member 115 can be an annular member arranged in the space between the member 110 and the projection optical system 30, and surrounding the projection optical system 30. According to the present exemplary embodiment, the inactive gas outlet port 123 can be arranged outside of the space between the projection optical system 30 and the member 110 if the normal line of the inactive gas outlet port 123 is directed to the space.

Further, according to the present exemplary embodiment, an inactive gas recovery port used for recovering inactive gas can be arranged on the face 113 of the member 110 opposing the projection optical system 30. Alternatively, the inactive gas recovery port can be provided on the member 115 on which the inactive gas supply port 123 is arranged or provided on a member different from the member 110 or the member 115.

According to the present exemplary embodiment, since the inactive gas can be supplied to the space between the projection optical system and the member having the supply port and the recovery port of the liquid, oxygen concentration in the periphery of the liquid can be reduced sufficiently and quickly. Further, since leakage of the inactive gas to the measurement area of the laser interferometer can be reduced, possibility of measurement error (interferometer error due to fluctuation) can be reduced.

### Third Exemplary Embodiment

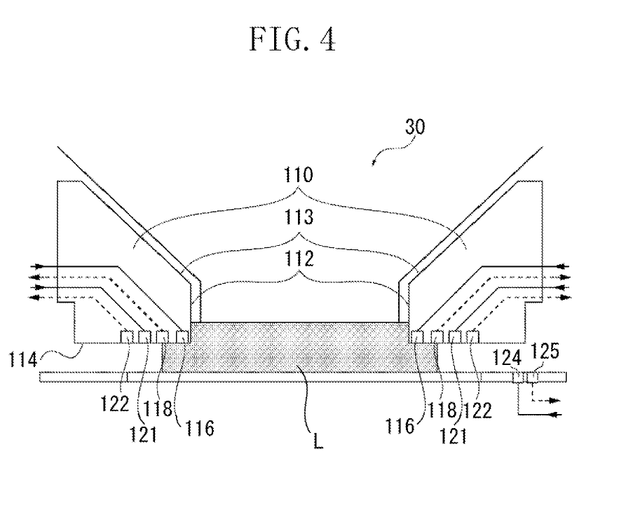

FIG. 4 illustrates a cross section of the optical path space according to a third exemplary embodiment of the present invention. The optical path space includes the optical axis of the projection optical system 30. According to the present exemplary embodiment, an inactive gas outlet port 124 and an inactive gas recovery port 125 are arranged on the wafer stage 45 on which the wafer 40 is mounted. The inactive gas recovery port 125 arranged on the wafer stage 45 also serves as a recovery port of the liquid (i.e., the immersion liquid). For example, the inactive gas recovery port 125 removes dissolved gas in the liquid by a vacuum deaerating device.

### Fourth Exemplary Embodiment

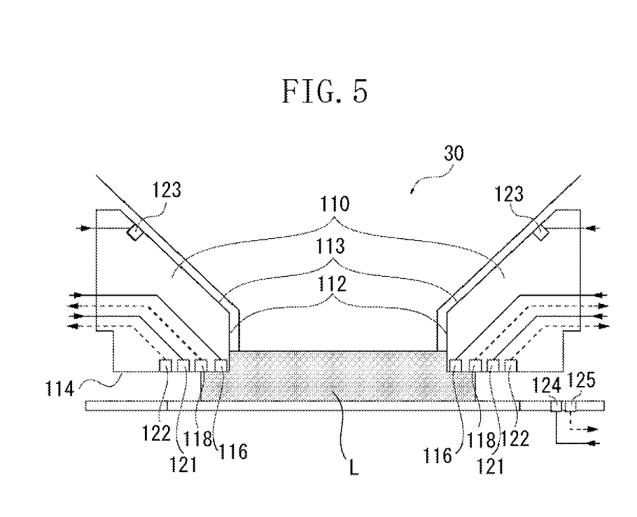

Further, according to the present exemplary embodiment, the inactive gas outlet port 123 can be arranged in a space between the projection optical system 30 and the member 110. For example, as illustrated in FIG. 5, the inactive gas outlet port 123 can be provided on the member 110. To be more specific, the inactive gas outlet port 123 can be arranged on the face 113 of the member 110 opposing the projection optical system 30 to supply inactive gas between the projection optical system 30 and the member 110.

### Fifth Exemplary Embodiment

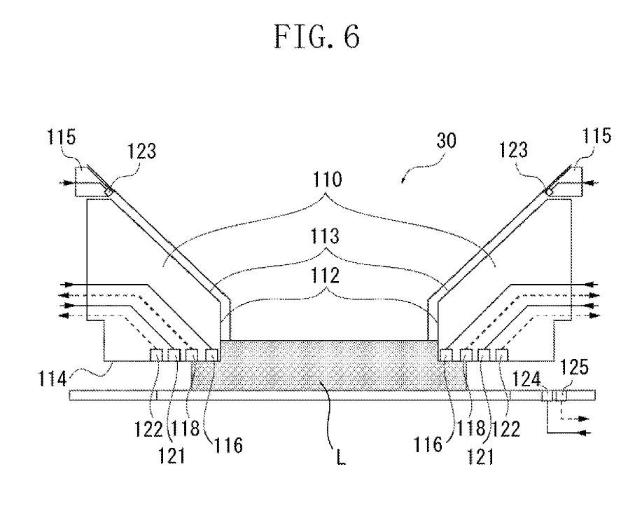

On the other hand, as illustrated in FIG. 6, the inactive gas outlet port 123 can be provided on the member 115 different from the member 110. The member 115 can be a piping with its outlet port directed to the space between the projection optical system 30 and the member 110. Alternatively, the member 115 can be an annular member different from the member 110 and arranged to surround the projection optical system 30.

Furthermore, according to the present exemplary embodiment, an inactive gas recovery port used for recovering inactive gas can be arranged between the member 110 and the projection optical system 30. The inactive gas recovery port can be provided on the face 113 of the member 110 opposing the projection optical system 30, on the member 115 on which the inactive gas supply port 123 is arranged, or on a member different from the member 110 or the member 115. An inactive gas recovery unit (not shown) is provided in the exposure apparatus 1 or in the external apparatus. Inactive gas in the space between the member 110 and the projection optical system 30 is recovered by the inactive gas recovery unit from the inactive gas recovery port through a piping. Alternatively, the inactive gas outlet port 123 can also function as an inactive gas recovery port, so that only one aperture is arranged on the face 113.

### Exemplary Exposure Method

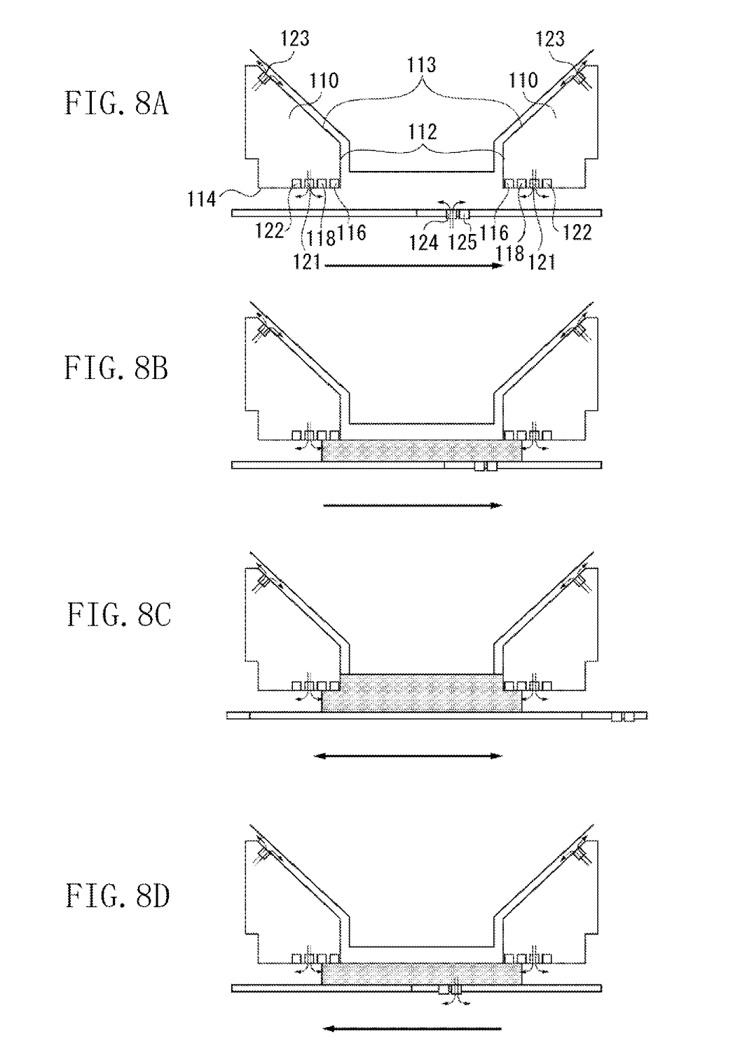

Next, an exposure method using the exposure apparatus according to the present exemplary embodiment will be described referring to FIGS. 7 and 8A through 8D. Arrows at the bottom of FIGS. 8A through 8D indicate a direction of movement of the wafer stage. Arrows at the apertures indicate flow of liquid or gas.

First, as illustrated in FIG. 8A, after mounting the wafer 40 on the wafer stage 45, the stage controller 60 moves the wafer stage 45 so that the wafer 40 is in the space below the projection optical system 30. Simultaneously, the fluid controller 70 causes the inactive gas outlet port 124 provided on the wafer stage 45 as well as the inactive gas outlet ports 121 and 123 provided on the member 110 to discharge inactive gas. Then, air in the space between the projection optical system 30 and the wafer 40 (the wafer stage 45) and air in the space between the projection optical system 30 and the member 110 is replaced with inactive gas to reduce the oxygen concentration in the spaces (steps S101 and S102). At this time, the fluid controller 70 controls a supply start and a flow volume of the inactive gas.

Next, as illustrated in FIG. 8B, the fluid controller 70 stops the supply of the inactive gas from the inactive gas outlet port 124, and then supplies the liquid to the space between the projection optical system 30 and the wafer 40 (the wafer stage 45) (Step S103). The liquid is supplied by the liquid supply apparatus 140 through the supply port 116. At this time, it is useful to supply the liquid while the wafer stage 45 is moving. By supplying the liquid while the wafer stage 45 is moving, the liquid supplied from an upstream side in a wafer stage scanning direction can move faster to the optical path space along with the movement of the wafer stage 45.

After the liquid is supplied to the space between the projection optical system 30 and the wafer 40 (the wafer stage 45) (i.e., the optical path space), the exposure apparatus 1 projects the pattern formed on the reticle 20 onto the wafer 40 as illustrated in FIG. 8C (step S104).

When projection of all shots is finished, as illustrated in FIG. 8D, the fluid controller 70 recovers the liquid by the liquid recovery unit 160 through the liquid recovery port 118 or the inactive gas recovery port 125 which also serves as a liquid recovery port. Further, the fluid controller 70 causes the inactive gas recovery unit to recover the inactive gas through the inactive gas recovery port (Step S105).

According to the exposure method of the present exemplary embodiment, the inactive gas is continuously discharged from the inactive gas outlet ports 121 and 123 arranged on the member 110. This continuous discharge of the inactive gas prevents the oxygen concentration of the liquid from increasing.

According to the present exemplary embodiment, since the inactive gas can be promptly supplied to the periphery of the liquid, oxygen concentration of the liquid can be reduced sufficiently and quickly. Further, since leakage of the inactive gas to the measurement area of the laser interferometer can be reduced, measurement error (interferometer error due to fluctuation) can be reduced.

### Other Exemplary Embodiments

Next, a method for manufacturing a device, such as a semiconductor IC device or a liquid crystal display element, using the above-described exposure apparatus will be described. The device is manufactured through processes including exposing a substrate (wafer, glass substrate), which is coated with photosensitive material, to light, developing the substrate (photosensitive material), and other known processes including etching, resist stripping, dicing, bonding, and packaging, using the above-described exposure apparatus. According to this device manufacturing method, a device with improved quality can be manufactured.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-261019 filed Oct. 4, 2007, which is hereby incorporated by reference herein in its entirety.

What is claimed is:

1. An exposure apparatus configured to expose a substrate through a liquid, comprising:
a projection optical system configured to project an image of a pattern formed on an original plate onto a substrate;
a stage configured to move while supporting the substrate;
a member including a supply port and a recovery port of the liquid that is arranged between the stage and the projection optical system such that a space is formed between the projection optical system and the member; and
a supply unit configured to supply inactive gas through an outlet port into the space between the projection optical system and the member;
wherein the outlet port is directed to the space.

2. The exposure apparatus according to claim 1, wherein the outlet port is provided in the space.

3. The exposure apparatus according to claim 1, wherein the outlet port is provided in the member.

4. The exposure apparatus according to claim 1, wherein while the outlet port is the first outlet port, a second outlet port is provided for blowing inactive gas to a liquid in a space between the substrate and the member, and wherein the first outlet port is provided at a position nearer an optical axis of the projection optical system than the second outlet port.

5. An exposure apparatus configured to expose a substrate through a liquid, comprising:
a projection optical system configured to project an image of a pattern formed on an original plate onto a substrate;
a stage configured to move while supporting the substrate;
a member including a supply port and a recovery port of the liquid that is arranged between the stage and the projection optical system such that a space is formed between the projection optical system and the member;
a supply unit configured to supply inactive gas through an outlet port into a space between the stage and the member; and
a recovery unit configured to recover the inactive gas supplied by the supply unit through a recovery port;
wherein the outlet port of the supply unit and the recovery port of the supply unit are provided on a face of the stage opposing the projection optical system.

6. The exposure apparatus according to claim 5, wherein the recovery unit recovers the inactive gas as well as the liquid through the recovery port of the recovery unit.

7. The exposure apparatus according to claim 5, wherein the outlet port is provided in the space between the projection optical system and the member.

8. The exposure apparatus according to claim 5, wherein the supply unit supplies the inactive gas while the stage is moving.

9. An exposure method for exposing a substrate through a projection optical system and a liquid by projecting an image of a pattern formed on an original plate onto the substrate, comprising:
supplying inactive gas in a space between a member including a supply port and a recovery port of the liquid, and the projection optical system through an outlet port directed to the space;
supplying the liquid to a space between the projection optical system and the substrate after supplying the inactive gas; and
exposing the substrate through the liquid supplied to the space between the projection optical system and the substrate.

10. A device manufacturing method comprising:
exposing a substrate using an exposure apparatus configured to expose a substrate through a liquid, the exposure apparatus comprising:
a projection optical system configured to project an image of a pattern formed on an original plate onto a substrate;
a stage configured to move while supporting the substrate;
a member including a supply port and a recovery port of the liquid that is arranged between the stage and the projection optical system such that a space is formed between the projection optical system and the member; and
a supply unit configured to supply inactive gas through an outlet port into the space between the projection optical system and the member;
wherein the outlet port is directed to the space and
developing the exposed substrate.

11. A device manufacturing method comprising:
exposing a substrate using an exposure apparatus configured to expose a substrate through a liquid, the exposure apparatus comprising:
a projection optical system configured to project an image of a pattern formed on an original plate onto a substrate;
a stage configured to move while supporting the substrate;
a member including a supply port and a recovery port of the liquid that is arranged between the stage and the projection optical system such that a space is formed between the projection optical system and the member;
a supply unit configured to supply inactive gas through an outlet port into a space between the stage and the member; and
a recovery unit configured to recover the inactive gas supplied by the supply unit through a recovery port;
wherein the outlet port of the supply unit and the recovery port of the supply unit are provided on a face of the stage opposing the projection optical system and
developing the exposed substrate.
